(19) United States
(12) Patent Application Publication
(10) Pub. No.: US 2006/0212154 A1
(43) Pub. Date: Sep. 21, 2006

(54) Method for representing a dental object and for producing dentures

(76) Inventors: Philip Von Schroeter, Rodenbach (DE); Michael Zoellner, Pegnitz (DE)

Correspondence Address: DENNISON, SCHULTZ & MACDONALD, 1727 KING STREET, SUITE 105, ALEXANDRIA, VA, 22314, US

(21) Appl. No.: 10/564,161

(22) PCT Filed: Jul. 7, 2004
(86) PCT No.: PCT/EP04/07406

§ 371 Date: Feb. 21, 2006

(30) Foreign Application Priority Data
Jul. 14, 2003 (DE) 103 31 989.1
Sep. 12, 2003 (DE) 103 42 537.3
Nov. 5, 2003 (DE) 103 52 217.4

(51) Int. Cl. A61C 5/10

(52) U.S. Cl. 700/118; 700/98; 433/223; 715/848

(57) ABSTRACT

A method for aligning digitized dentures displayed on a screen using an input device and a rectangular coordinate system with X, Y and Z axis. The aim of the invention is to provide a method which allows the intuitive and simple alignment of virtual models of teeth or rows of teeth or dentures within the scope of visualizing scan data and the CAD modeling of dentures. For this purpose, the Z axis of the coordinate system extends in the plane of the screen and the X axis extends perpendicularly thereto. The origin of the coordinate system intersects the object displayed on the screen and the object is aligned on the screen by a maximum of five degrees of freedom.

The invention concerns a procedure for representing a digitized, technical dental object, such as artificial dentures or a model of at least a tooth on a screen using as a basis a right-angled coordinate system with X, Y and Z axes, whereby the Z-axis and the Y-axis, as well as their intersection (origin of the coordinate system) in the representation plane of the screen, and the X-axis run perpendicular to the representation plane, and the technical dental object rotates around two axes running perpendicular to each other and is adjusted along the X-axis for zooming in on the object. Furthermore, the invention refers to a procedure for manufacturing artificial dentures using as a basis digitized data of the area of the jaw which is to be provided with artificial dentures.

Standard mice were developed for navigation in two-dimensional systems essentially for positioning a mouse pointer on a screen, especially a PC screen. With such mice, two translation degrees of freedom can be steered and operated over an additional adjusting wheel if the need for a further function should arise.

With a complete three-dimensional adjustment (object is moved) or navigation (camera, especially viewer is moved), the control of six degrees of freedom is necessary, i.e. three degrees of freedom for the translation and three for the rotation. In order to realize this, mostly a combination of keyboard strokes and mouse movements occur. Thus, an intuitive operation is not possible; it requires substantial exercise and a longer training period.

For navigation, especially aligning in the three-dimensional area, different input devices, such as joysticks and trackballs were developed. With these input devices, all six degrees of freedom can usually be intuitively steered if a precise navigation, especially aligning, requires substantial training. A chief problem here is the undesired overlapping of two or more motion directions.

In the dental area, no system is known with which a 3D-alignment of a dental model occurs by means of an input device which is in agreement with the interests of the respective task, i.e. the user respectively. Rather, standard mice are usually used.

From WO-A 1998/53428, a procedure is to be taken, in order to be able to accomplish an orthodontic diagnosis. For this, it is proposed that a jaw impression is gradually turned around the Y-axis and the Z-axis, which lie in the representation plane of the screen. Furthermore, the possibility exists of zooming along the X-axis.

In order to represent objects in different positions on a screen, input elements are known whereby, for example, by means of a SpaceMouse®, zooming and turning, especially moving, the object to the necessary extent. From U.S. Pat. No. 5,557,714 a procedure is to be taken in order to be able to rotate a three-dimensional model around two axes running perpendicular to each other.

Input keyboards, in order to adjust positions around six degrees of freedom, are known, for example, from EP-A 1 283 495 or DE-C 44 05 314.

The present invention has as its basis further development of a procedure of the kind initially specified, that an intuitive and simple adjustment of virtual models of technical dental objects, in particular of teeth or rows of teeth is made possible in the framework of visualizing scanned data, as well as CAD-Modellation of artificial dentures. Furthermore, the possibility is to be created, due to the digitized data of the area of the jaw which is to be provided with artificial dentures, as one or more tooth stems, to easily examine artificial dentures, which are virtually represented on the screen, in order to be able to then manufacture the desired artificial dentures based on these data.

The problem is solved through a procedure for representing a digitized technical dental object of the kind initially specified, essentially by the fact that the technical dental object runs along the plane, which is stretched from the X-axis and the Y-axis, as well as the origin of the coordinate systems is aligned interspersing the T-axis, and moved over maximally five degrees of freedom, whereby the first degree of freedom is in a rotation (Rot_{z}) around the Z-axis, the second degree of freedom is a rotation around the T-axis (Rotₜ), the third degree of freedom can be selected as a translation of the object along the T-axis, and the fourth degree of freedom can be selected as a translation of the object along the X-axis. Thus, it is proposed that the technical dental object is aligned to the coordinate system in such a manner that its origin always intersperses the represented technical dental object.

If a rotation around the X-axis as the fifth degree of freedom can be chosen after a further development of the invention, it is preferable, however, to propose that the technical dental object is maximally moved corresponding to the first, the second, the third and the fourth degrees of freedom.

In order to additionally facilitate an intuitive and simple adjustment of the represented technical tooth object, a further training of the invention plans that the rotation around the T-axis is limited, i.e. a tilting motion essentially occurs. Thus, the object can be rotated around the T-axis at an angle α with α<360°, in particular α≦180°.

Additionally, a limited movement can take place along the T-axis, without losses being sustained regarding the representation of the technical dental object.

In a further development of the invention, it is proposed that the longitudinal axis of the technical dental object is formed by connecting straight lines through a polygonal transverse draft with sections of the technical dental object, such as centers of the sections of the manufactured artificial dentures, such as a crown, that for adjusting a technical dental object along the T-axis excluding moving along the straight line of the polygonal transverse draft, which transverses the origin of the coordinate system. Therefore, for adjusting the technical dental object, the sequential angle β with β≠180°, including the first and second straight lines is proposed, after completing the adjustment along the first straight line for adjusting the technical dental object along the second straight line, that the technical dental object is rotated around at an angle β around the Z-axis, so that, consequently, the course of the second straight line corresponds, according to direction, to the preceding course of the first straight line.

Contrary to technical 3D-CAD systems, with whose assistance objects can be represented and manipulated—this requires an object movement around all 6 degrees of freedom—a simplified reduction occurs with the CAD-Modellation of artificial dentures, according to the invention, of 4 or 5 degrees of freedom. It is sufficient to consider the virtual dental crowns and the area of the jaw which is to be provided with them. Surrounding areas, such as jaw bones, lips, and the tongue are not of importance for technical dental restorations, and were, thus, also not digitized. Also, the tooth root, which is covered by the gums and the inside of the tooth, is not taken into account with computer-assisted tooth restoration.

In other words, the invention plans a procedure for adjusting a represented, digitized section of an object, in particular, a row of teeth, in a coordinate system on the screen, using an input device, whereby the object is aligned around a maximum of five, preferably four, degrees of freedom:
1. Rotation around the Z-axis through the coordinate origin,
2. Rotation around the longitudinal axis of the object (Z-axis), which runs along the row of teeth through the coordinate origin, whereby the rotation is preferably reduced, thus effecting a tilting,
3. Translation of the object along the longitudinal axis of the object (T-axis) and, in as much as is limited, since the coordinate origin always lies inside the object, and
4. Translation along the X-axis from the coordinate origin to the viewer (zoom),
   whereby the origin of the coordinate system should essentially remain on the screen or in its center. Thus, the Z-axis coincides with the vertical axis of the technical dental object, if this is not rotated around the T-axis.

By representing larger cutaways of the dental arch, the longitudinal axis of the object (T) can be formed by a polygonal transverse draft, which is compounded from cutaways, which can consist of straight-lined connections between, for example, crown centers.

In particular, the invention shows a process of manufacturing artificial dentures, such as bridges or crowns, taking into account digitized data that provide the area of the jaw with artificial dentures, as single or several stems, calculating the artificial dentures on the basis of the digitized data and representing at least the artificial dentures on a screen, examining the represented artificial dentures by moving them on the screen at around five degrees of freedom maximally, in particular, however, four degrees of freedom, evaluating, and, if necessary, changing the represented artificial dentures and performing the manufacturing of the artificial dentures according to the corresponding data. Thus, digitized data can be linked with accessible parameters, such as wall thickness of the manufactured artificial dentures and/or a cement gap between the artificial dentures and the enclosing stem of the area of the jaw.

Since an examination of the represented artificial dentures results in the fact that this does not correspond to the conceptions, a set value, respectively, then an electronic modeling can take place, in order to then manufacture the artificial dentures on the basis of the data, which is changed in such a way.

Reference is expressly made to the digitalization of the jaw area which is to be provided with the artificial dentures, as well as the manufacturing of artificial dentures on the basis of digitized values, thus according to the CAD-CAM procedure, for example, which is described in WO-A-99/47065.

Naturally, the possibility also exists that not only the artificial dentures, but also the jaw area on which the artificial dentures are to be introduced is represented, in order to be able to carry out an optical examination on the screen.

In a further development of the invention, it is proposed that the input device which is used for aligning the objects exhibit input elements, over which the aligning of the object around the respective degrees of freedom are carried out separately from each other. Thus, such an input device is used, in particular, with four input elements, whereby an input element can be a changeover switch for duplicating a further input element.

In the configuration, it is proposed as an adjusting wheel with one of several input elements. Also, the functions of at least two input elements of an exercised trackball are used as an input device.

According to a preferred implementation, such a device is used as an input device, which contains a first and a second input element, each rotating around at least one axis, as well as a key as the third input device, whereby at the operation of the first input element, the object is rotated around a first axis (T-axis), and, at the operation of the second input element, the object is rotated around a second axis (Z-axis), which runs perpendicular to the first axis, at the simultaneous operation of the third input element and that of the first or second input elements, the object is shifted along one of the axes, and at the operation of the third input elements and that of the second or first input elements, the representation of the objects is adjusted along the axis that is perpendicular to the first and second axes (Zoom) (along the X-axis).

When using a trackball as one of the input elements, the object can be rotated around the first and second axis, as well as around an axis running perpendicular to this axis by a similar rotation of the trackball.

According to an alternative suggestion, it could be proposed that the input device exhibits control elements, such as adjusting wheels, with which one of the four object movements can be implemented in isolation.

The control elements are arranged for an intuitive operability toward the required movements. For example, the rotation is controlled around the vertical axis by an adjusting wheel with a perpendicular axis of rotation, the turning around the longitudinal axis of the object and the two translations by the adjusting wheels with horizontal or approximately horizontal axes of rotation.

Thus, a control element for two or three similarly oriented movements (e.g. tilts and zoom shots) can be used for decreasing expenditures in construction, if it is occupied several times by a changeover switch.

In a further example, both rotations are combined by using a ball (trackball).

The use of a ball (trackball) permits the inclusion of the rotation around the third axis without an additional control element. In this case, the object movement is limited to 5 degrees of freedom.

Furthermore, the use of a standard mouse is proposed, with which the four movements are realized through combinations of mouse movement, key actuation and manipulation of the adjusting wheel (Scroll). However, not all mouse movements and control elements correspond to the movements of the object.

In particular, an input device is proposed, which enables the movement of the technical dental object around four degrees of freedom. The input device covers three first adjusting wheels with, in each case, an axis running approximately parallel to an operator hand and a fourth adjusting wheel with an approximately perpendicular-running axis. Thus, two first adjusting wheels are, in each case, rotating around an axis, which fall or run parallel to each other and the remaining first adjusting wheel rotates around an axis that runs perpendicular to this axis. Between the two first adjusting wheels, which are ordered parallel to each other and the first remaining adjusting wheel, which runs perpendicular, the fourth adjusting wheel is arranged.

With a relevant development of the input device, problem-free operation is possible with one hand, with which, to the desired extent, the technical dental object is represented on the screen and is able to be adjusted by the viewer.

Independent of this, whether the adjustment concept according to the invention is limited to four or five degrees of freedom in an application-specific environment, a limited movement of the object takes place additionally, in particular regarding the translation movement along the longitudinal axis of the object (T-axis), as well as, if necessary, a reduced rotation (tilting) around this axis. A complete rotation should be possible, however, at least around the perpendicular and the Z-axis, which run orthogonal to the T-axis.

According to the invention and deviating from technical CAD-Systems, an object adjustment by restricting the degrees of freedom, as well as by separating the individual movements can be simplified. Thus, according to the invention, the model can be used by people with little or average PC experience. In-depth and expensive training courses or long training periods are thus not necessary. A simple, intuitive operation is possible.

Further details, advantages and features of the invention result not only from the claims and features disclosed therein, per se, or in combination, but also from the following description of the preferred embodiments shown in the drawings, wherein

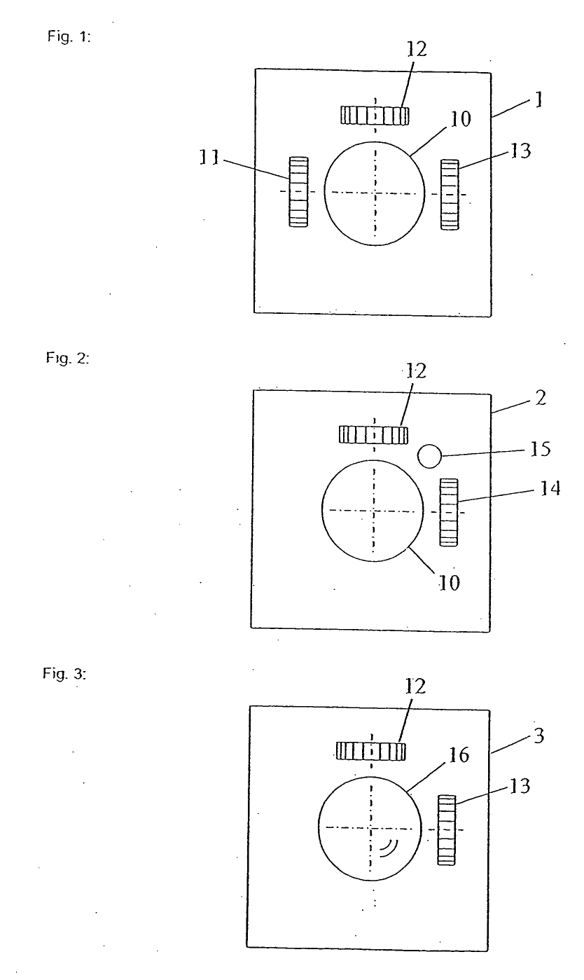

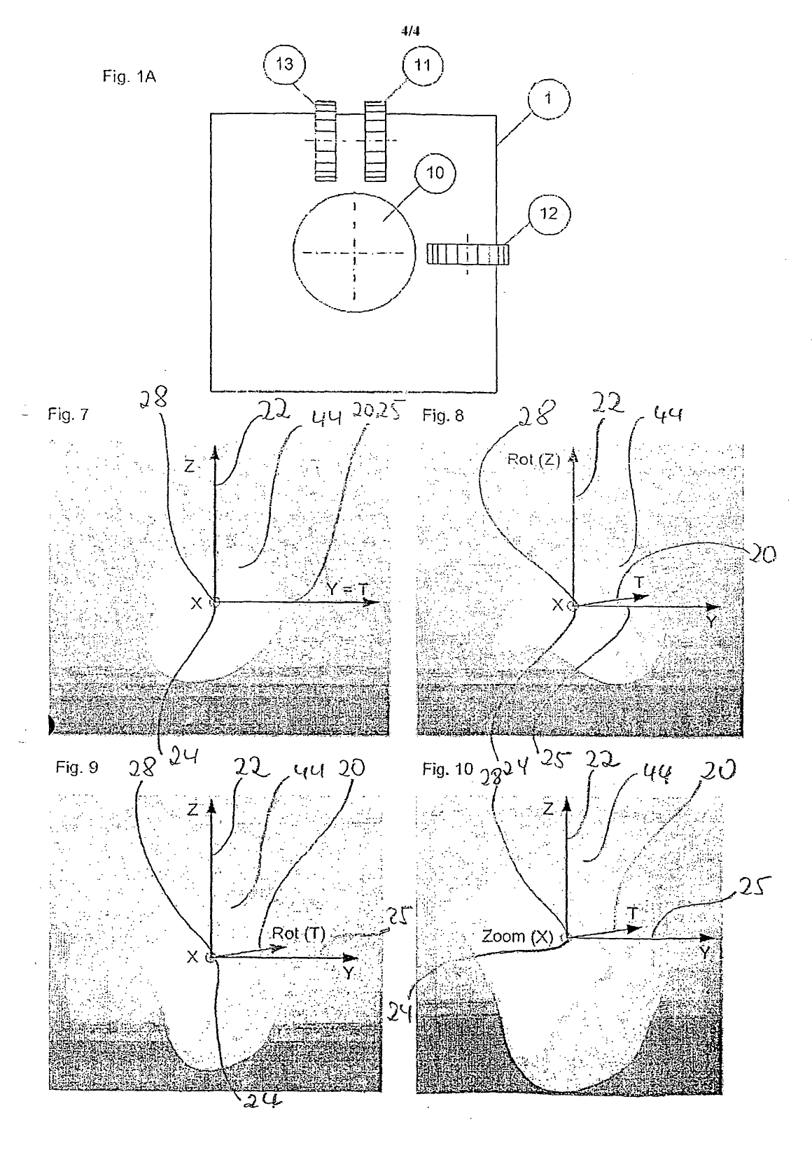

FIG. 1 a principle representation of an input device with four adjusting wheels,

FIG. 1a an arrangement of the input device according to FIG. 1,

FIG. 2 a principle representation of an input device with three adjusting wheels and a changeover switch (key),

FIG. 3 a principle representation of an input device with a ball (trackball) and two adjusting wheels,

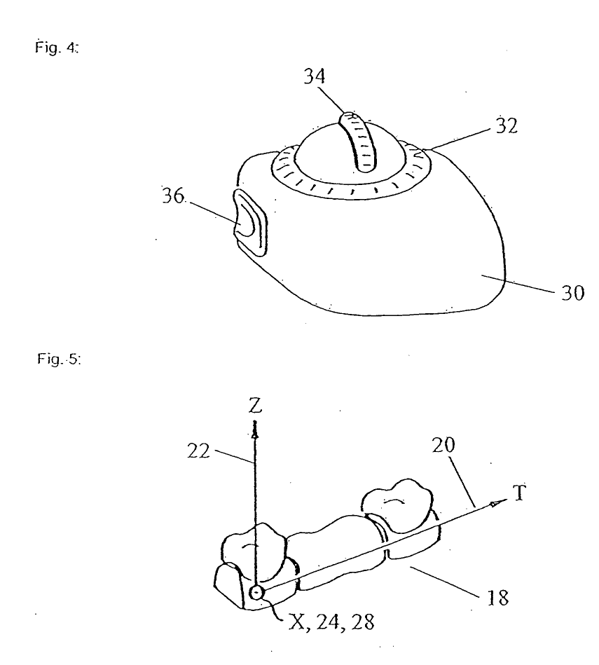

FIG. 4 a principle representation of a further diagram of an input device,

FIG. 5 a principle representation of a short row of teeth for illustrating the adjustment concept, especially the navigator concept,

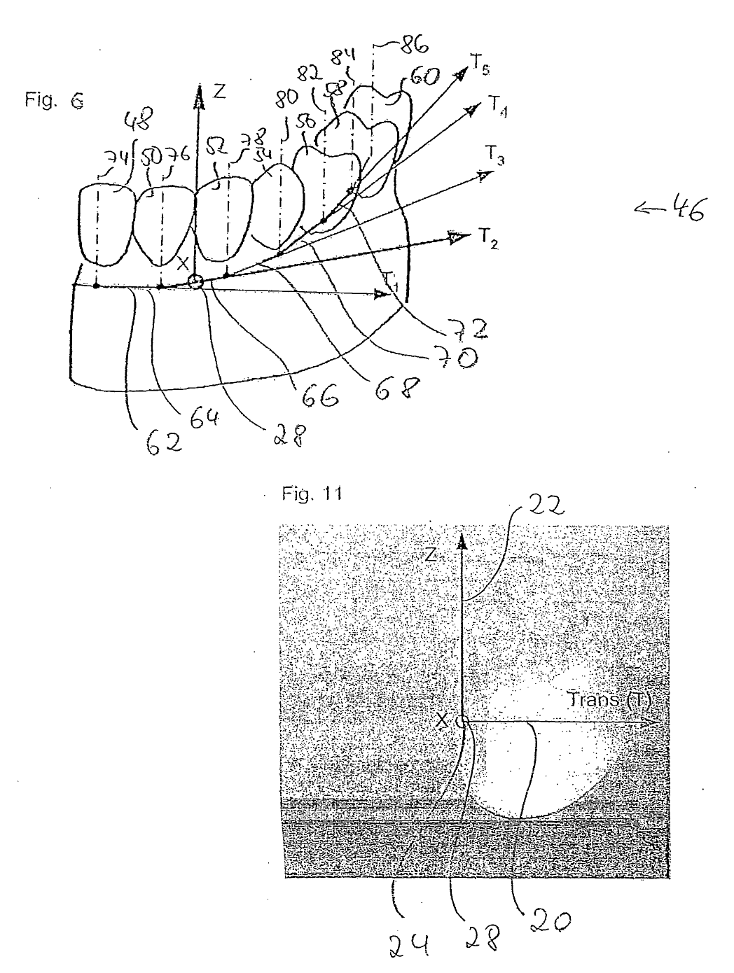

FIG. 6 a principle representation of a bridge section, whose longitudinal axis is formed by a polygonal traverse draft,

FIG. 7 representation of a technical dental object in starting position,

FIG. 8 the technical dental object according to FIG. 7 after rotating around the Z-axis,

FIG. 9 the technical dental object according to FIG. 8 after rotating around the Z-axis,

FIG. 10 the technical dental object according to FIG. 9 after shifting along the Z-axis and

FIG. 11 the technical dental object according to FIG. 7 after shifting along the T-axis.

In FIGS. 1 to 3, four diagrams 1, 2, 3 of an input device are represented, in order to enable an adjustment of a virtual model of artificial dentures, such as caplets 14, or model 18, 46 of a section of the jaw in the context of visualizing scanned data or the CAD-Modellation of artificial dentures.

By operating individual input elements 10, 11, 12, 13, 14, 15, 16, 32, 34, 36, or, respectively, a combined use of these, which are attached to a PC, the possibility exists on the screen, with which input device 1, 2, 3 is connected, that an object, such as the model of a section of the jaw or of the artificial dentures 44 in an application-specific environment with preferably four or, if necessary, five degrees of freedom of limited movement, can be navigated.

The model 18, 46 of a section of the jaw or of the artificial dentures 44 is navigable in a right-angled coordinate system with X, Y and Z axes. In the coordinate system, a T-axis, which is designated by reference symbol 20, runs perpendicular to the Z-axis 22, and in one of the X-axis 24 and the Y-axis 25 of the right-angled coordinate system of the stretched plane, whereby the T-axis 20 and the Y-axis 25 dependent on the rotation of object 18, 26, 44 around the Z-axis 22 fall or are able to describe an angle to each other, as this results from the graphic representation. Independent of this, the X-axis 24, the Y-axis 25, as well as the T-axis 20 and the Z-axis 22, originate from a coordinate origin 28, which preferably runs in the center of the screen.

The T-axis 20 coincides with the center axis of the digitized elongated object 18, thus, of the model section. The T-axis ends at the object border, which is, however, beyond that indicated. In order to shift object 18 along the T-axis 20 (apparent shift of the coordinate origin 28)(Transₜ), by using all three variants of the input device 1, 2, 3, the adjusting wheel 12 is turned. In order to enable a limited rotation (tilting) around, for example, approximately 180° around the T-axis 20 (Rotₜ), the adjusting wheel 11 is turned with input device 1, and, with input device 2, adjusting wheel 14 is turned. With input device 3, the ball (trackball) 16 is rotated around a horizontal axis, which runs parallel to the center axis (T) of the digitized object.

In order to effect a complete rotation around the Z-axis 22 (Rol_{z}), by input devices 1 and 2, the adjusting wheel 10 is operated, by input device 3, the ball 16 is rotated around its vertical axis (Z). In order to finally enable a zoom, therefore, to effect a translation along the axis 24, which runs through the coordinate origin 28 and perpendicular to the axes 22, 25, by the input devices 1 and 3, the adjusting wheel 13 is used and by the input device 2, the key is pressed and held and, in addition, the adjusting wheel 14 is turned. Thus, the model section cannot be “lost,” since the coordinate origin 28 remains in the center of the screen.

The input device 3 additionally enables a rotation around the X-axis 24, which runs orthogonal to the vertical axis (Z-axis) and the Y-axis. In addition, the ball 16 is turned around a horizontal axis, which runs parallel to the axis of rotation of the placing axis 12.

With the input devices 1, 2 or 3, an adjustment concept, custom-designed on four degrees of freedom of limited movement, and full rotation around the vertical axis, the Z-axis 22 respectively is possible, as is limited translation (Transₜ) along the T-axis 20, and, if necessary, the limited rotation (tilting) around the T-axis 20. A further limiting and thus simplifying condition is, that the coordinate origin 28, in principle, lies in the center of the screen. Therefore, the represented object 18, 26, 44 can never be outside of the screen cutout at zoom. This movement, which is limited to four degrees of freedom, is realized, according to that which has already been mentioned, with the input devices 1, 2, and 3. The full rotation around the Z-axis 22 is realized by operating the tension ring 10, ball 16 respectively, the limited translation is realized along the T-axis 20 by the tension ring 12, the limited rotation (tilting) around the T-axis 20 is realized by the adjusting wheel 11, respectively adjusting wheel 14 by the ball 16 and the translation along the plane (zoom), which runs perpendicular to the screen plane, is realized through adjusting wheel 13, respectively, 14 with a held key 15.

FIG. 1a is an arrangement of an input device 1 that can be taken, which corresponds to FIG. 1 regarding the elements, or the number and function of the input device 1, so that for the same elements, the same reference numbers are used.

Thus, the axes of rotation of the adjusting wheels 11, 12 and 13 run along an operator hand, whereas the axis of rotation of the adjusting wheel 10 runs perpendicular to this. Furthermore, two adjusting wheels—11 and 13 in the diagram—are arranged parallel to each other and beside each other and are, consequently, more or less rotating around a same axis, respectively around axes that run parallel to each other. Likewise, the adjusting wheel 12 runs along the hand operator of an axis of rotation running perpendicular regarding that of the adjusting wheels 11 and 13, so that these areas in total enclose an approximate right angle. Between the adjusting wheels 11 and 13, which are arranged beside each other, and that with its axis approximately 90° to this turned adjusting wheel 12, the adjusting wheel 10 is arranged. Thus, its axis runs in the intersection of a center plane, which is stretched from the adjusting wheel 12 and a plane, which runs between adjusting wheels 11 and 13, so that a good acquisition of the adjusting wheels 10, 11, 12, 13 results in only one hand for operation, preferable the left hand. With the adjusting wheel 12, a movement of a technical tooth object along the T-axis can be carried out. For this, the thumb is preferably used. With the adjusting wheel 11, it can be operated with an index finger, and a turn can take place around the T-axis. With the middle adjusting wheel 10, which again can be moved with the thumb, a turn can take place around the Z-axis. Finally, the adjusting wheel 13 is preferably operated with the middle finger, in order to be able to carry out a shifting of the objects along the X-axis, therefore to affect a desired Zoom.

If an adjustment concept with a custom-designed limited movement of five degrees of freedom, then an input device can be used, which contains a Trackball, as well as two tension rings.

By using the appropriate input elements individually or in combination, the possibility exists of carrying out a rotation around the T-axis, a rotation around the Z-axis, a rotation around the X-axis, which runs perpendicular to the screen level and the Z-axis, a limited translation along the T-axis, also along the longitudinal extension of the object to be navigated, as well as a translation along the X-axis, which runs orthogonal to the screen level (Zoom). This can take place due to the following input element use:
the rotation around the horizontal axis (T-axis) by a similar turn of the Trackball,
the rotation around the vertical axis (Z-axis) by a similar turn of the Trackball,
the rotation around the perpendicular to the horizontal and vertical running axis by a similar turn of the trackball,
the limited translation along the longitudinal extension of the object, thus of the T-axis through the first tension ring, and
the zoom (translation) along the axis running perpendicular to the monitor level through the second tension ring

In FIG. 4, a further diagram of an input device 30 is represented, in order to enable navigation of a virtual model of teeth or rows of teeth in the context of a visualization of scanned data or the CAD Modellation of artificial dentures. The mouse 30 contains a disk or a tension ring (“JOGDIAL”) 32 as the first control element and an enclosed turning wheel (“Scroll”) 32 or a Trackball as the second control element, as well as a key 36 as the third control element.

Through operating the individual input elements or a combination thereof, it is possible to navigate an object, on the screen which is attached to the PC with which the mouse is connected, , such as the model section 18, 26, custom-designed movement reduced to four or five degrees of freedom, in order to shift the object 18, 26 along the T-axis 20 (apparent shifting of the coordinate origin) (Transₜ), by using he input device 30, the key 36 is used together with the disk or the tension ring 32. In order to enable a reduced rotation (dumps) around approximately 180° around the T-axis (Rotₜ), the disk, respectively, the tension ring 34 is used.

In order to affect a complete turning around the Z-axis 22 (Rot_{z}), adjusting wheel 32 is used. In order to finally enable a zoom, to therefore effect a translation along the coordinate origin 28 and the axis 24, which runs perpendicular to the axis 22, key 36 and adjusting wheel 34 are used simultaneously. Thus, the object 18 can not be “lost,” since the coordinate origin 28 remains in the center of the screen.

The theory, according to the invention, for navigating a technical dental object on a screen, whereby the technical dental object is maximally movable around five, preferably four degrees of freedom, is, on the basis of FIGS. 7 to 11, to be described in greater detail. Thus, a caplet 44 is regarded as a technical dental object.

In FIG. 7, the caplets 44 are found in the starting situation, i.e. the origin 28 of the coordinate system runs approximately concentric in the caplet 44. The Z-axis, which falls with the vertical axis of the caplet 44, is, as before, marked by the reference number 22, and the Y-axis is marked with the reference number 25. Perpendicular to the Y-axis 25 and the Z-axis 22, thus, to that, from the representation level of the screen of the stretched plane, runs the X-axis 24, which establishes the origin 28. The Y-axis 25 coincides, in the start position of the caplet 44, with the T-axis 20, which stretches along the longitudinal axis of caplet 44. If the caplet 44 is rotated around the Z-axis 22 as the first degree of freedom (Rot(Z)), it moves according to the T-axis 20, which occurs from the representation of FIG. 8.

In FIG. 9, a tilt (Rot(T)) occurs around the T-axis 20 at the second degree of freedom. A shift of the caplet 44 along the T-axis 20 as the third degree of freedom is clarified through FIG. 11. Thus, the T-axis 20 runs in the representation plane and, accordingly, coincides with the Y-axis 25. However, this is not an absolute characteristic. Finally, as a fourth degree of freedom, the shift of caplet 44 along the X-axis is clarified in FIG. 10, without the Y-axis 25 and the T-axis 20 having to coincide.

FIG. 11 further conveys that the movement of caplet 44 along the T-axis 20 occurs limited to that effect, that the caplet 44 is, in principle, positioned in such a way to the origin 28, that the caplet 44 separates an otherwise represented technical dental object.

In FIGS. 5 and 7-11, a multi-element model section 18, a caplet 44 is represented, whose respective longitudinal axis runs along a straight line and is aligned along the T-axis 20. The theory, according to the invention, is, however, also able to be realized for technical dental objects, by which the artificial dentures or the model section whose longitudinal axis runs along the arch, as can be deduced from FIG. 6. In this figure, a multi-element model section 46 is represented, which consists of the individual members 48, 50, 52, 54, 56, 58, 60. A traverse 62 is fitted to the arch, on which the members 48, 50, 52, 54, 56, 58, 60 are arranged. The transverse 62, for its part, is made up of straight lines 64, 66, 68, 70, 72, as is clarified on the basis of FIG. 6. Thus, the straight lines 64, 66, 68, 70, 72 run between midpoints 74, 76, 78, 80, 82, 84, 86 of the members 48, 50, 52, 54, 56, 58, 60 of the multi-element model section 46.

In order to turn or tilt the multi-element model section 46 around the T-axis as the second degree of freedom, or in order to shift it along the T-axis as the third degree of freedom, a straight line of the traverse 62 must always establish the origin 28 of the coordinate system, whereby the corresponding straight line, which is straight line 66 in the diagram and which gives a present effective T-axis (in the diagram T₂ axis), which can be shifted along the multi-element model section 46, respectively turned and/or tilted around this axis.

At shifting the model section 46 along the traverse, a straight line 62, 64, 66, 68, 70, 72 must always establish the origin 28. When switching from a straight line to another straight line, it is, thus, not necessary that the model section 46 be turned. Rather, the present T-axis in effect changes according to the course of the traverse 26, which fixes the second and third degrees of freedom. In other words, an alignment of the respective, present effective T-axis on a previous axis or a following axis is not necessary.

Alternatively, the possibility exists, by shifting the model section 46 along the traverse 62, which fixes the apparent longitudinal axis, which the established T-axis momentarily aligns the origin 28, in such a way, that every T-axis established the origin 28, which encloses the same angle for the X-axis, the Y-axis respectively, of the coordinate system. Consequently, if the model section 16 is first shifted along the straight line 66, so then the model section 46 is turned in such a way around the Z-axis 22, if the inflection point 88, respectively 90, which borders the straight line 64, respectively 68, is attained, that the fixed axes T₁, respectively T₃, coincide, through the straight line 64, respectively 68 with the previous axis T₂.

In other words, the model section 46 is rotated around the Z-axis 22 around an angle, which corresponds to the angle which contains the straight lines 64, 66, or 66, 68. Accordingly, the model section is successively shifted to the origin 28 and rotated.

On the basis of the theory, according to the invention, an intuitive and simple alignment of a virtual model, respectively, virtual artificial dentures, in the context of the visualization of scan data and the CAD Modellation of artificial dentures is enabled.

1. Procedure for representing a technical digital object, such as artificial dentures or at least a model of a tooth or the area of the jaw which will provided with the artificial dentures, on a screen, on the basis of a right-angled coordinate system with X, Y and Z axes, whereby the Z-axis and the Y-axis and the intersection (origin of the coordinate systems) in the representation plane of the screens and the X-axis run perpendicular to the representation plane and the technical dental object is rotated around two axes running perpendicular to each other and is shifted along the X-axis for zooming the object, characterized in that the technical dental object is aligned along a stretched plane, in which the X-axis and the Y-axis run, and the T-axis established the origin of the coordinate system and is moved around a maximal five degrees of freedom, whereby a rotation (Rot_{z}) is chosen as the first degree of freedom around the Z-axis, a rotation (Rotₜ) is chosen as the second degree of freedom around the T-axis, a translation of the object along the T-axis is chosen as the third degree of freedom and the translation of the object along the X-axis is chosen as the fourth degree of freedom.

2. Procedure according to claim 1, characterized in that the technical dental object is maximally moved around the first, second, third and fourth degrees of freedom.

3. Procedure according to claim 1, characterized in that as a fifth degree of freedom, a rotation (Rotₓ) of the object around the X-axis is chosen.

4. Procedure according to claim 1, characterized in that the technical dental object is maximally rotated around an angle around the T-axis, whereby α<360°, particularly α≦180° is selected.

5. Procedure according to claim 1, characterized in that the technical dental object is represented on the screen in such a way that the technical dental object is established independent of its movement or representation from the origin of the coordinate system.

6. Procedure according to claim 1, characterized in that the longitudinal axis of the technical dental object is formed through a traverse with the connected straight lines of the sections of the technical dental object, that for shifting of the technical dental object along the T-axis the technical dental object is shifted along a straight line of the traverse, which establishes the origin of the coordinate system.

7. Procedure according to claim 6, characterized in that by shifting the technical dental object along the first and second straight lines, which follow each other and contain an angle β where β≠180° after completing the shifting along the first straight line before shifting the technical dental object along the second straight line, the technical dental object is rotated around an angle β around the Z-axis.

8. Procedure according to claim 1, characterized in that a reduced translation of the object results along the T-axis.

9. Procedure according to claim 1, characterized in that the coordinate system with its origin is specified on the screen in such a way that the origin remains independent of the movement of the object in fixed position on the screen.

10. Procedure according to claim 1, characterized in that the coordinate origin is placed approximately in the center of the screen.

11. Procedure according to claim 1, characterized in that the reduced rotation is realized around the T-axis (second degree of freedom) by the object rotating to and from.

12. Procedure according to claim 1, characterized in that at aligning the object on the screen, the input device used exhibits input element, over which the alignment of the object is arranged around the respective degree of freedom separated from each other.

13. Procedure according to claim 9, characterized in that as an input device, such a one with four input elements in used.

14. Procedure according to claim 9, characterized in that as an input element, a changeover switch is used for duplicating a further input element.

15. Procedure according to claim 9, characterized in that as one or several input elements an adjusting wheel is used.

16. Procedure according to claim 1, characterized in that as the input device, a function of at least two input elements of an exercised trackball.

17. Procedure according to claim 9, characterized in that by using a trackball (ball) as one of the input elements, the object is rotated around the first and second axis, as well as around an axis that runs perpendicular to this axis through a similar rotation of the trackball.

18. Procedure according to claim 9, characterized in that the object through optional operation of an individual input element, as well as combinatory operation of two input elements is moved around four degrees of freedom in a limited fashion.

19. Procedure for manufacturing artificial dentures on the basis of digitized data of a jaw area which is to be provided with the artificial dentures, assessing the artificial dentures based on the digitized data and representation at least of the artificial dentures on a screen, according to claim 1, evaluating the represented artificial dentures through moving the artificial dentures on the screen maximally around five degrees of freedom, and, if necessary, changing the represented artificial dentures and the subsequent manufacture of the artificial dentures on the basis of the data that correspond to the represented artificial dentures.

20. Procedure according to claim 19, characterized in that the artificial dentures and the jaw area to be provided with the artificial dentures be represented on the screen.

21. Procedure according to claim 20, characterized in that assessing the artificial dentures based on the digitized data of the jaw area to be provided with the artificial dentures with stored parameters, such as wall thickness of the artificial dentures or cement gap between the artificial dentures and jaw area combined and from such data attained, the artificial dentures are assessed and represented on the screen.

22. Procedure according to claim 19, characterized in that the artificial dentures, which are represented on the screen, are modeled by an electronic change of the data.

23. Procedure according to claim 19, characterized in that the artificial dentures and/or the jaw area is maximally shifted around four degrees of freedom on the screen.
